(19) United States
(12) Patent Application Publication
(10) Pub. No.: US 2012/0183760 A1
(43) Pub. Date: Jul. 19, 2012

(54) LOW DIELECTRIC SHEET FOR 2-D COMMUNICATION, PRODUCTION METHOD THEREFOR, AND SHEET STRUCTURE FOR COMMUNICATION

(75) Inventors: Kiyoaki Kodama, Ibaraki-shi (JP); Makoto Saitou, Ibaraki-shi (JP); Hiroichi Ukei, Ibaraki-shi (JP); Toshihiko Tomita, Ibaraki-shi (JP)

(73) Assignee: NITTO DENKO CORPORATION, Ibaraki-shi, Osaka (JP)

(21) Appl. No.: 13/499,225

(22) PCT Filed: Sep. 29, 2010
(86) PCT No.: PCT/JP2010/066944

§ 371 Date: Mar. 29, 2012

(30) Foreign Application Priority Data
Sep. 30, 2009 (JP) 2009-229040
Sep. 28, 2010 (JP) 2010-216402

(51) Int. Cl. B32B 3/26; C08J 9/08

(52) U.S. Cl. 428/314.4; 264/53

(57) ABSTRACT

Disclosed are: a low dielectric sheet which is used for 2-D communication, can be used in a sheet structure for 2-D communication, and has the lowest dielectric constant and dielectric loss tangent to date; a production method therefor; and a 2-D communication structure using the dielectric sheet for 2-D communication. Specifically disclosed is a low dielectric sheet which is used for 2-D communication and is characterized by having a density of 0.01 to 0.2 g/cm³ and a dielectric constant of no more than 1.6. In particular, a foam that comprises cells and has a dielectric loss tangent of no more than 0.01 is preferred.

### TECHNICAL FIELD

The invention relates to a low-dielectric sheet for two-dimensional communication for forming a communication medium for use in two-dimensional communication, a method for manufacture therefor, and a communication sheet structure produced by using the low-dielectric sheet for two-dimensional communication.

### BACKGROUND ART

Communication technologies conventionally used include one-dimensional communication using ISDN line or LAN cable connection and three-dimensional communication using radio waves or infrared rays, such as wireless LAN. The development of such communication technologies enables connection to the Internet and information exchange from everywhere in home or office.

Unfortunately, one-dimensional communication has complicated cabling or wiring problems, and particularly in an office where a lot of people work, one-dimensional communication has problems with handling and storing of cables. In three-dimensional communication, such problems are eliminated because of no use of cables, but there have been pointed out problems such as the risk of information leakage and interference with peripheral equipment, due to the transmission of signals through space.

In recent years, there has been proposed a two-dimensional (sheet-shaped) communication medium as means for solving these problems. This enables communication with personal computers having a wireless LAN function through electromagnetic waves generated on the surface of the sheet, which needs no cable connection and can reduce the risk of information leakage because increasing the distance from the sheet makes the communication impossible.

It is also known that based on the same principle, electric power is transmitted in a noncontact manner using electromagnetic waves transmitted through a sheet. The electric power transmitted in such a manner is at a level of several watts, and the distance through which the transmission is possible is limited to several mm or less. For example, however, when a personal computer having a wireless LAN function as mentioned above is used on such a sheet, information communication and electric supply are both possible, which increases convenience.

There has been proposed a communication sheet structure for use in such two-dimensional communication, which includes an upper layer (electrically-conductive layer)/an intermediate layer (dielectric layer)/a lower layer (electromagnetic wave-shielding layer) (see Patent Documents 1 to 3). Particularly, it is disclosed that the intermediate layer has a dielectric loss tangent of 0.01 or less in the range of 800 MHz to 5 GHz and that beyond the range, electromagnetic energy cannot be held in the sheet, so that energy loss is generated and communication performance is significantly reduced.

### PRIOR ART DOCUMENTS

### Patent Documents

Patent Document 1: Japanese Patent Application Laid-Open (JP-A) No. 2008-160615
Patent Document 2: JP-A No. 2008-160616
Patent Document 3: JP-A No. 2008-206074

### SUMMARY OF THE INVENTION

### Problems to be Solved by the Invention

The use of a dielectric sheet with a low dielectric loss tangent in a communication sheet structure as mentioned above is a very important issue for the improvement of communication performance. Unfortunately, Patent Documents 1 to 3 only disclose dielectric sheets with a dielectric loss tangent of down to 0.007 in the range of 800 MHz to 5 GHz. Besides dielectric loss tangent, dielectric constant is also an important factor for the improvement of communication performance, but the patent documents are silent on this point. In general, a reduction in the dielectric loss represented by the formula below is effective in reducing transmission loss (degradation in communication performance) in the high frequency range, and it is desirable that both the dielectric constant and the dielectric loss tangent should be low.

Ad=27.3×(f/C)×(tan δ)×(∈)^{1/2}, wherein Ad is dielectric loss, f is frequency (Hz), ∈ is dielectric constant, C is light speed, and tan δ is dielectric loss tangent.

It is therefore an object of the invention to provide: a low-dielectric sheet for two-dimensional communication that can be used to form a two-dimensional communication sheet structure and has a dielectric constant lower than ever before; a method for manufacture therefor; and a two-dimensional communication sheet structure produced by using such a low-dielectric sheet for two-dimensional communication.

### Means for Solving the Problems

As a result of earnest studies to solve the above problems, the inventors have successfully developed a low-dielectric sheet with a dielectric constant lower than ever before.

Thus, the invention provides a low-dielectric sheet for two-dimensional communication, having a density of 0.01 to 0.2 g/cm³ and a dielectric constant of 1.6 or less.

The low-dielectric sheet for two-dimensional communication of the invention preferably has a dielectric loss tangent of 0.01 or less.

The low-dielectric sheet for two-dimensional communication of the invention preferably contains cells, and in particular, the cells preferably have an average cell diameter of 1 to 300 μm.

The low-dielectric sheet for two-dimensional communication of the invention is preferably made from a thermoplastic resin composition, and in particular, the thermoplastic resin composition preferably contains at least a polyolefin resin.

The low-dielectric sheet for two-dimensional communication of the invention preferably has an electrically-conductive layer on at least one side.

Specifically, in the low-dielectric sheet for two-dimensional communication of the invention, the electrically-conductive layer preferably has a surface resistivity of 1Ω or less per 1 cm², and the electrically-conductive layer preferably has a thickness of 0.1 mm or less.

The low-dielectric sheet for two-dimensional communication of the invention preferably has a bending rigidity of 100 N·mm² or less.

The invention also provides a communication sheet structure including the above low-dielectric sheet for two-dimensional communication.

The invention also provides a method for manufacturing a low-dielectric sheet for two-dimensional communication, which includes foaming and molding a resin composition to form a resin foam with a density of 0.01 to 0.2 g/cm³ and a dielectric constant of 1.6 or less.

In the method of the invention for manufacturing a low-dielectric sheet for two-dimensional communication, the resin composition is preferably foamed using a high-pressure gas.

The high-pressure gas is preferably carbon dioxide or nitrogen, and a supercritical fluid is preferably used as the high-pressure gas.

### EFFECTS OF THE INVENTION

When used to form a two-dimensional communication sheet structure, the low-dielectric sheet for two-dimensional communication of the invention, which has a dielectric constant lower than ever before, can significantly increase the communication performance. According to the method of the invention for manufacturing a two-dimensional communication sheet, a low-dielectric sheet for two-dimensional communication with a low dielectric constant can be efficiently provided by a simple and easy method.

### BRIEF DESCRIPTION OF DRAWING

FIG. 1 is a view showing an embodiment of the communication sheet structure of the invention, in which part (a) is a schematic cross-sectional view of it, and part (b) is a schematic top view of it.

### EMBODIMENTS FOR CARRYING OUT THE INVENTION

The low-dielectric sheet for two-dimensional communication of the invention is characterized by having a density of 0.01 to 0.2 g/cm³ and a dielectric constant of 1.6 or less. The sheet having such a low dielectric constant is preferably a foamed sheet containing cells.

(Resin Composition)

The low-dielectric sheet for two-dimensional communication of the invention can be obtained from a resin composition containing at least a resin and optionally containing powder particles or an additive(s). The resin composition as a raw material for the low-dielectric sheet for two-dimensional communication preferably includes, but is not limited to, a thermoplastic resin in view of moldability (ease of the production of the foam) and recyclability. The thermoplastic resin may be polyolefin resin, polyvinyl chloride resin, polyester resin, polystyrene resin, polyvinyl acetate resin, acrylic resin, ABS resin, polyamide resin, or the like. These thermoplastic resins may be used alone or in combination of two or more. Among these thermoplastic resins, polyolefin resin is preferably used, because of its relatively low dielectric constant and dielectric loss tangent.

Examples of polyolefin resin include, but are not limited to, low-density polyethylene, medium-density polyethylene, high-density polyethylene, linear low-density polyethylene, polypropylene, ethylene-propylene copolymers, copolymers of ethylene or propylene and any other α-olefin (such as butene-1, pentene-1, hexene-1, or 4-methylpentene-1), and copolymers of ethylene and any other ethylenic unsaturated monomer (such as vinyl acetate, acrylic acid, acrylic ester, methacrylic acid, methacrylic ester, or vinyl alcohol). The polyolefin reins may be used alone or in combination of two or more. When the polyolefin resin is a copolymer, it may be in the form of any of a random copolymer and a block copolymer.

The polyolefin resin that may be used is preferably a resin of such a type that the molecular weight distribution is broad and has a shoulder on the high molecular weight side, a slightly crosslinked type resin (slightly crosslinked resin), or a long-chain, branched type resin.

In an embodiment of the invention, a rubber component and/or a thermoplastic elastomer component may also be used together with the thermoplastic resin to form the resin composition. When a rubber component and/or a thermoplastic elastomer component is used, flexibility is provided in the in-plane direction, so that the communication sheet structure being formed is less likely to wrinkle even when it is folded or wound into a roll. The content of the rubber component and/or the thermoplastic elastomer component is not restricted. The mixing ratio (% by weight) of the thermoplastic resin to the rubber component and/or the thermoplastic elastomer component (the former/the latter) is typically 1/99 to 99/1 (preferably 10/90 to 90/10, more preferably 20/80 to 80/20). If the content of the rubber component and/or the thermoplastic elastomer component in the mixture of the thermoplastic resin and the rubber component and/or the thermoplastic elastomer is less than 1% by weight, the resin composition may be more likely to form a foamed sheet with low flexibility. On the other hand, if it is more than 99% by weight, gas leakage may be more likely to occur during foaming, which will make it difficult to obtain a highly foamed product.

The rubber component or the thermoplastic elastomer component may be any material having rubber elasticity and preferably capable of foaming, examples of which include natural or synthetic rubber such as natural rubber, polyisobutylene, polyisoprene, chloroprene rubber, butyl rubber, or nitrile butyl rubber; olefin-based elastomers such as ethylene-propylene copolymers, ethylene-propylene-diene copolymers, ethylene-vinyl acetate copolymers, polybutene, and chlorinated polyethylene; styrene-based elastomers such as styrene-butadiene-styrene copolymers, styrene-isoprene-styrene copolymers, and hydrogenation products thereof; polyester elastomers; polyamide elastomers; and various thermoplastic elastomers including polyurethane elastomers. These rubber or thermoplastic elastomer components may be used alone or in combination of two or more. These rubber or thermoplastic elastomer components typically have a glass transition temperature equal to or lower than room temperature (for example, 20° C. or less). Therefore, when a polyolefin resin foam containing the rubber component or the thermoplastic elastomer component is used to form the low-dielectric sheet for two-dimensional communication, flexibility and shape-following properties can be significantly increased.

An olefin-based elastomer is preferably used as the rubber component and/or the thermoplastic elastomer component. In general, the olefin-based elastomer has a micro-phase separated structure of an olefin-based resin component and ethylene-propylene rubber, and has good compatibility with polyolefin resins.

In an embodiment of the invention, when the resin composition for use in forming the low-dielectric sheet for two-dimensional communication is foamed, the resin composition preferably further contains power particles. Namely, the resin composition for use in foam molding preferably contains a thermoplastic resin and powder particles. The powder particles can function as a foam nucleating agent during foam molding. Therefore, when powder particles are added, a resin foam of good foam quality can be obtained. When powder particles are used in the resin composition and when a supercritical-state fluid is used to form a high-pressure gas serving as a foaming agent in foaming the resin composition, a resin foam having particularly fine and uniform cells can be obtained.

For example, such powder particles may be made of talc, silica, alumina, zeolite, calcium carbonate, magnesium carbonate, barium sulfate, zinc oxide, titanium oxide, aluminum hydroxide, magnesium hydroxide, mica, clay such as montmorillonite, carbon particles, glass fibers, carbon tubes, or the like. A single type of powder particles may be used alone, or two or more types of powder particles may be used in combination.

For example, the added amount of the powder particles are appropriately selected from, but not limited to, the range of 5 to 150 parts by weight, preferably the range of 10 to 130 parts by weight, more preferably the range of 20 to 120 parts by weight, based on 100 parts by weight of the resin component (polymer component) of the resin composition. If the added amount of the powder particles is less than 5 parts by weight based on 100 parts by weight of the resin component (polymer component), a uniform foam may be difficult to be obtained. On the other hand, if it is more than 150 parts by weight, the resin composition may have a significantly increased viscosity and cause gas leakage during the formation of a foam so that foam properties may be lost.

The average particle size of the powder particles is typically, but not limited to, about 0.1 to about 10 μm, preferably about 0.5 to about 5 μm. If the average particle size of the powder particles is less than 0.1 μm, they may fail to sufficiently function as a nucleating agent, and an average particle size of more than 10 μm may cause gas leakage during foam molding.

The resin composition also has flammable properties (of course, which is also a disadvantage). Therefore, when the low-dielectric sheet for two-dimensional communication to be produced by using the resin composition needs to be flame-retardant, flame-retardant powder particles (such as any of various powdery flame retardants) are preferably added. It will be understood that the flame retardant may be used together with non-flame-retardant powder particles.

Such a flame retardant is preferably an inorganic flame retardant. For example, the inorganic flame retardant may be a bromine-based flame retardant, a chlorine-based flame retardant, a phosphorus-based flame retardant, an antimony-based flame retardant, or the like. When burned, chlorine-based flame retardants and bromine-based flame retardants can produce gas components harmful to human body and corrosive to equipment, and phosphorus-based flame retardants and antimony-based flame retardants have a problem such as toxicity or explosibility. Therefore, non-halogen, non-antimony inorganic flame retardants are preferably used. Examples of non-halogen, non-antimony inorganic flame retardants include aluminum hydroxide, magnesium hydroxide, and hydrated metal compounds such as magnesium oxide-nickel oxide hydrates and magnesium oxide-zinc oxide hydrates. Hydrated metal oxides may have undergone surface treatment. A single flame retardant may be used alone, or two or more flame retardants may be used in combination.

When a flame retardant is used, for example, the amount of the flame retardant used may be appropriately selected from, but not limited to, the range of 8 to 70% by weight, preferably the range of 25 to 65% by weight based on all of the resin composition. If the amount of the flame retardant used is too small, the flame retardant effect may be low. On the other hand, if it is too large, a highly foamed product may be difficult to be obtained.

In an embodiment of the invention, the resin composition may further contain an aliphatic compound. An aliphatic compound has high crystallinity, and when added to a polyolefin resin, an aliphatic compound can form a strong film on the resin surface. Therefore, an aliphatic compound can inhibit collapse of the cells of a foam and improve shape recovery ability, because it can be considered that the aliphatic compound serves to prevent blocking between resin wall surfaces, which form cells.

At least one selected from a fatty acid, a fatty acid amide, and a fatty acid metal soap may be used as the aliphatic compound. An aliphatic compound having a highly polar functional group is less compatible with a polyolefin resin and therefore can easily precipitate on the resin surface, so that it can easily produce the above effect. The melting point of the aliphatic compound is from 50 to 150° C., preferably from 70 to 100° C., from the standpoint of lowing molding temperature, reducing degradation of the polyolefin resin composition, and imparting sublimation resistance.

The fatty acid preferably has about 18 to about 38 carbon atoms (more preferably 18 to 22 carbon atoms), examples of which include stearic acid, behenic acid, and 12-hydroxystearic acid. Among them, behenic acid is particularly preferred. The fatty acid amide is preferably a fatty acid amide having a fatty acid moiety of about 18 to about 38 carbon atoms (more preferably 18 to 22 carbon atoms), which may be any of a monoamide and a bisamide. Specific examples include stearic acid amide, oleic acid amide, erucic acid amide, methylenebisstearic acid amide, and ethylenebisstearic acid amide. Among them, erucic acid amide is particularly preferred. The fatty acid metal soap may be an aluminum, calcium, magnesium, lithium, barium, zinc, or lead salt of the above fatty acid. In particular, the aliphatic compound is preferably a fatty acid or a fatty acid amide.

The content of the aliphatic compound is typically from 1 to 20 parts by weight, preferably from 5 to 15 parts by weight, more preferably from 8 to 13 parts by weight, based on 100 parts by weight of the resin component (polymer component) of the resin composition. If the content of the aliphatic compound is less than 1 part by weight, a sufficient amount of the component cannot precipitate on the resin surface, so that the shape recovery effect may be difficult to be obtained. If the content is more than 20 parts by weight, the resin may be plasticized, so that it may fail to keep a sufficient pressure in an extruder, which will reduce the content of a foaming agent, such as carbon dioxide, in the resin, so that a high foaming ratio cannot be obtained and that it may be difficult to obtain a foam with a satisfactory foam density.

If necessary, the resin composition used to form the low-dielectric sheet for two-dimensional communication of the invention may contain various additives. Any type of additive may be used, and for example, various additives commonly used in foam molding may be used. Examples of additives include a foam nucleating agent, a crystal nucleating agent, a plasticizer, a lubricant, a coloring agent (such as a pigment or a dye), an ultraviolet absorbing agent, an antioxidant, an age resistor, a filler, a reinforcing agent, an antistatic agent, a surfactant, a tension modifier, an anti-shrink agent, a fluidity modifier, clay, a vulcanizing agent, a surface-treatment agent, a flame retardant in any form other than a powder, a dispersing aid, and a polyolefin resin modifier. The amount of the additive to be added may be arbitrarily selected as long as cell formation or the like is not inhibited, and the amount used in the formation of common thermoplastic resin may be used.

(Resin Foam)

The low-dielectric sheet for two-dimensional communication of the invention can be obtained by a process including foaming and molding the resin composition as a raw material to form a resin foam.

In order to obtain a sheet with a low dielectric constant according to the invention, a foamed sheet containing cells is preferably formed. The foam is also preferably a foamed sheet containing a large amount of fine cells and having a high foaming ratio (low density).

Specifically, the sheet produced from the resin composition has a dielectric constant and a dielectric loss tangent derived from the materials contained therein, and when the sheet contains cells, its dielectric constant and its dielectric loss tangent will be close to the dielectric constant (1.00) and the dielectric loss tangent (0.00) of air. In order to increase the contribution of cells, the content of cells can be increased, namely, the foaming ratio can be increased (the density can be reduced). However, if only the density is simply reduced, the mechanical properties, such as strength and flexibility, of the sheet may be reduced. In order to maintain the mechanical properties, therefore, it is preferred to form a foam containing a large number of fine cells with a small average cell diameter. It is not easy to produce such a low-density foam containing a large amount of fine cells, and it has not been known that such a foamed sheet is used as a low-dielectric sheet for two-dimensional communication.

The low-dielectric sheet for two-dimensional communication of the invention preferably has a density of 0.01 to 0.2 g/cm³, more preferably 0.015 to 0.15 g/cm³, in particular, preferably 0.02 to 0.1 g/cm³. If the foam density is more than 0.2 g/cm³, low dielectric loss tangent or dielectric constant may be difficult to be obtained. If the foam density is less than 0.01 g/cm³, the low-dielectric sheet for two-dimensional communication may have significantly reduced strength.

The density of the low-dielectric sheet for two-dimensional communication may be determined by a process including stamping a test piece out of the low-dielectric sheet for two-dimensional communication, determining the volume and weight of the test piece, and calculating the density from the following formula: density (g/cm³)=the weight of the test piece/the volume of the test piece.

A foam containing cells is preferably used in the low-dielectric sheet for two-dimensional communication of the invention. In this case, the cells preferably have an average cell diameter of 1 to 300 μm, more preferably 2 to 200 μm, in particular, preferably 5 to 100 μm. If the average cell diameter is more than 300 μm, the shape holding ability (the strength of the foam) may be reduced. If it is less than 1 μm, the resulting porosity may be insufficient, and low dielectric loss tangent or dielectric constant may be difficult to be obtained. The average cell diameter can be determined by analyzing a magnified image of the foam using image analysis software.

Such a resin foam is preferably produced using a non-limiting foaming method including foaming the resin composition by using a high-pressure gas (a foaming method including impregnating the resin composition with a high-pressure gas as a foaming agent and then reducing the pressure (releasing the pressure)). In a physical foaming method (a method of foaming by a physical method), there are concerns about the inflammability or toxicity of the substance used as a foaming agent and an influence on the environment, such as ozone layer depletion, but the foaming method using a high-pressure gas is an environment-friendly method because of no use of such a foaming agent. In a chemical foaming method (a method of foaming by a chemical method), a foaming gas residue remains in the foam, which may cause the problem of contamination with corrosive gas or impurities in the gas particularly in electronic equipment applications where lower contamination is strongly demanded, but the foaming method using a high-pressure gas enables the production of a clean foam without such impurities. It is also said that in both of physical and chemical foaming methods, a fine cell structure is difficult to be formed, particularly, fine cells of 100 μm or less are very difficult to be formed.

The high-pressure gas may be of any type as long as it is inert to the resin composition and impregnation with it is possible. Examples of such a gas include air and inert gases (such as carbon dioxide (carbonic acid gas), nitrogen, and helium). Any mixture of these gases may be used. Among them, inert gases, with which the amount and rate of impregnation can be large and high, are preferably used, and among inert gases, carbon dioxide or nitrogen is particularly preferably used.

Also, in order to increase the impregnation rate, the high-pressure gas (particularly, carbon dioxide) is preferably a supercritical fluid. Under supercritical conditions, the solubility of the gas in the resin composition is high, so that a high concentration of the gas can be mixed into the resin composition. Also when the pressure is sharply dropped after impregnation, high-concentration impregnation can be achieved as described above, so that the production of cell nuclei can be increased, which makes it possible to obtain fine cells, because the cell nuclei can grow to form high-density cells even when the porosity is at the same level. Carbon dioxide has a critical temperature of 31° C. and a critical pressure of 7.4 MPa.

The resin foam may be manufactured by a batch method including previously molding the resin composition into an appropriate shape such as a sheet shape to form an unfoamed, molded resin product (unfoamed molded product), then impregnating the unfoamed, molded resin product with a high-pressure gas, and releasing the pressure to allow foaming, or by a continuous method including kneading the resin composition with a high-pressure gas under increased pressure and molding the mixture while releasing the pressure, so that molding and foaming are simultaneously performed. Therefore, a pre-molded, unfoamed resin product may be impregnated with an inert gas, or the molten resin composition may be impregnated with an inert gas under increased pressure, and then the resin composition may be subjected to molding in the process of reducing the pressure.

Specific examples of the method of producing an unfoamed, molded resin product in the process of manufacturing a resin foam by a batch method include: a method of molding a polyolefin resin-containing resin composition by using an extruder such as a single screw extruder or a twin screw extruder; a method including uniformly kneading the resin composition by using a kneading machine having blades, such as a roller, cam, kneader, or banbury type and press-molding the composition into a product with a predetermined thickness by hot plate pressing or the like; and a molding method using an injection molding machine. Molding may be performed by any appropriate method capable of forming a molded product with the desired shape and thickness. The resulting unfoamed, molded resin product is placed in a pressure-resistant vessel (high-pressure vessel) and subjected to: a gas impregnation process including injecting (introducing) a high-pressure gas (such as carbon dioxide) so that the unfoamed, molded resin product is impregnated with the high pressure gas; a pressure reducing process including releasing the pressure (generally to atmospheric pressure) at the time when sufficient impregnation with the high-pressure gas is achieved, so that cell nuclei are produced in the polyolefin resin; and optionally (if necessary) a heating process including growing the cell nuclei by heating, so that cells are formed in the polyolefin resin. It will be understood that cell nuclei may be grown at room temperature with no heating process. After cells are grown in this way, if necessary, sudden cooling with cold water may be performed to fix the shape, so that a polyolefin resin foam is successfully obtained. The introduction of the high-pressure gas may be performed continuously or discontinuously. In the process of growing cell nuclei, a known or common heating method may be used such as a method using a water bath, an oil bath, a heating roller, a hot blast oven, far infrared rays, near infrared rays, or a microwave. In addition, the unfoamed, molded resin product (unfoamed molded product) to be used may be not only in the form of a sheet but also in any of various forms depending on the intended use. The unfoamed, molded resin product may also be produced by any other molding method than extrusion molding, press molding, and injection molding.

On the other hand, a resin foam can be manufactured by a continuous method, for example, which includes: a kneading and impregnating process including injecting (introducing) a high-pressure gas (such as carbon dioxide) while kneading a polyolefin resin-containing resin composition by using an extruder such as a single screw extruder or a twin screw extruder, so that the polyolefin resin is sufficiently impregnated with the high-pressure gas; and a molding and pressure-reducing process including releasing the pressure (generally to atmospheric pressure) by extruding the resin composition through a die attached to the front end of the extruder so that molding and foaming can be performed simultaneously. Optionally (if necessary), a heating process may also be performed, in which cells are grown by heating. After cells are grown in this way, if necessary, sudden cooling with cold water may be performed to fix the shape, so that a polyolefin resin foam is successfully obtained. The kneading and impregnating process and the molding and pressure-reducing process may be performed by using an injection molding machine as well as an extruder. A method capable of forming a polyolefin resin foam in a sheet shape, a prism shape, or any other shape may be selected as needed.

The added amount of the high-pressure gas is typically, but not limited to, 2 to 10% by weight, based on the total amount of the resin composition. The high-pressure gas may be mixed in an appropriately controlled amount so that the desired density or foaming ratio can be obtained.

In the gas impregnation process of the batch method or the kneading and impregnating process of the continuous method, the pressure at which the unfoamed, molded resin product or the resin composition is impregnated with a high-pressure gas may be appropriately selected taking into account the type of the gas, operability, and so on. For example, when carbon dioxide is used as the gas, the pressure is preferably 3 MPa or more (for example, about 3 to about 100 MPa), more preferably 4 MPa or more (for example, about 4 to about 100 MPa). If the pressure of the gas is lower than 3 MPa, cells may significantly grow during foaming, so that the cell diameter may become too large, which is not preferred because a problem such as a reduction in dielectric constant or dielectric loss tangent may easily occur. This is because when the pressure is low, the amount of gas impregnation is small relative to that at high pressure, and the cell nucleus-forming rate is reduced, so that the number of cell nuclei formed is reduced, which conversely increases the amount of the gas per cell, so that the cell diameter increases extremely. Also in the pressure range lower than 3 MPa, the cell diameter and the cell density are significantly changed only by slightly changing the impregnation pressure, and therefore, the cell diameter and the cell density tend to be difficult to control.

In the gas impregnation process of the batch method or the kneading and impregnating process of the continuous method, the temperature at which the unfoamed, molded resin product or the resin composition is impregnated with a high-pressure gas depends on the type of the high-pressure gas or the thermoplastic resin used, and it may be selected from a wide range. In view of operability or the like, for example, it is from about 10 to about 350° C. In the batch method, for example, the impregnation temperature at which a sheet-shaped, unfoamed, molded resin product is impregnated with a high-pressure gas is from about 10 to about 200° C. (preferably from 40 to 200° C.). In the continuous method, the temperature at which a high-pressure gas is injected and kneaded into the resin composition is generally from about 60 to about 350° C. When carbon dioxide is used as the high-pressure gas, the temperature during the impregnation (impregnation temperature) is preferably 32° C. or more (in particular, 40° C. or more) in order to maintain a supercritical state.

In the pressure-reducing process, the pressure-reducing rate is preferably, but not limited to, about 5 to about 300 MPa/s in order to obtain uniform fine cells. In the heating process, the heating temperature is typically from about 40 to about 250° C. (preferably from 60 to 250° C.).

In order to obtain a low-dielectric sheet for two-dimensional communication having a low dielectric loss tangent and a low dielectric constant, the foaming ratio of the resin foam obtained as described above is preferably, but not limited to, 5 times or more (for example, 5 to 50 times), more preferably 15 times or more (for example, 15 to 40 times). If the foaming ratio is less than 5 times, a low dielectric loss tangent or a low dielectric constant may be difficult to be obtained, and if the foaming ratio is more than 50 times, the foam may have significantly reduced strength.

The foaming ratio of the polyolefin resin foam is calculated from the following formula: foaming ratio (times)=the density (g/cm³) of the unfoamed product (the unfoamed, molded resin product)/the density (g/cm³) of the foamed product. The density of the unfoamed product can be determined in the same manner as described above for the density of the foamed product.

The thickness of the resin foam is typically, but not limited to, 0.5 to 5 mm, preferably 0.5 to 2 mm, while it may be arbitrarily selected depending on the shape, mode, or other characteristics of the communication sheet structure. When the foamed resin composition is used to form the low-dielectric sheet for two-dimensional communication, a resin foam with a high foaming ratio can be produced by the above method of producing a resin foam with a high-pressure gas, which is advantageous in that a thick resin foam can be produced. For example, when the resin foam is manufactured by the continuous method, the gap of the die attached to the tip end of an extruder should be as narrow as possible (generally 0.1 to 1 mm) so that the pressure inside the extruder can be maintained in the kneading and impregnating process. Therefore, in order to obtain a thick polyolefin resin foam, the resin composition extruded through the narrow gap should be foamed at a high ratio. Conventional techniques cannot achieve a high foaming ratio and therefore can only form thin foams (for example, of about 0.5 to about 2 mm). In contrast, the process of producing a resin foam with a high-pressure gas makes it possible to continuously obtain a foam with a final thickness of 0.5 to 5 mm.

The cell structure of the resin foam as described above is preferably a closed cell structure or a semi-continuous, semi-closed cell structure (a cell structure including a mixture of a closed cell structure and a continuous cell structure, in which the ratio between them is not restricted). In the semi-continuous, semi-closed cell structure, the closed cell structure part preferably makes up 40% or less, in particular, preferably 30% or less of the cell structure.

Depending on the type of the high-pressure gas and the resin used, the thickness, density, foaming ratio, average cell diameter, and other properties of the resin foam can be controlled, for example, by appropriately selecting or setting: the temperature, pressure, time, or other operating conditions in the gas impregnation process or the kneading and impregnating process; the pressure-reducing rate, temperature, pressure, or other operating conditions in the pressure reducing process or the molding and pressure-reducing process; or the heating temperature or the like in the heating process after the pressure reduction or the molding and pressure reduction.

(Low-Dielectric Sheet For Two-Dimensional Communication)

The low-dielectric sheet for two-dimensional communication of the invention, which can be obtained as described above, is characterized by having a dielectric constant of 1.6 or less, preferably 1.4 or less, more preferably 1.3 or less, in particular, preferably 1.2 or less (and generally 1.0 or more). When the dielectric constant is 1.6 or less, the energy loss (dielectric loss) in the dielectric layer can be reduced, which produces the advantageous effect of preventing generation of heat or noise and reducing power consumption. In the invention, a value measured by cavity resonator perturbation method may be used as the dielectric constant.

The low-dielectric sheet for two-dimensional communication of the invention also preferably has a dielectric loss tangent of 0.01 or less, more preferably 0.005 or less, in particular, preferably 0.002 or less, extremely preferably 0.001 or less (and generally 0.000 or more), at a frequency of 1 GHz. When the dielectric loss tangent is 0.01 or less, the energy loss (dielectric loss) in the dielectric layer can be reduced, which produces the advantageous effect of preventing generation of heat or noise and reducing power consumption. In the invention, a value measured by cavity resonator perturbation method may be used as the dielectric loss tangent.

Any shape may be selected as the shape of the low-dielectric sheet for two-dimensional communication of the invention, and examples of the shape include a film shape, a sheet shape, a plate shape, and a prism shape. The shape may also include a curved shape such as a wound shape, a bent shape, or a bow shape.

The structure of the low-dielectric sheet for two-dimensional communication is not restricted and may be a single layer structure or a laminated structure.

When the low-dielectric sheet for two-dimensional communication has a single layer structure, the low-dielectric sheet for two-dimensional communication preferably includes a foamed layer made of the resin foam. Therefore, the low-dielectric sheet for two-dimensional communication may be a single layer product consisting of a foamed layer made of the resin foam.

The low-dielectric sheet for two-dimensional communication of a single layer structure can be obtained by directly using the resin foam as the foamed layer or by cutting the resin foam into a piece with the desired shape or thickness if necessary.

When the low-dielectric sheet for two-dimensional communication has a laminated structure, for example, the low-dielectric sheet for two-dimensional communication may include a laminated structure of non-foamed layers each made of the resin composition, a laminated structure of foamed layers each made of the resin foam, or a laminated structure of a non-foamed layer made of the resin composition and a foamed layer made of the resin foam. Preferably, the laminated structure includes a foamed layer made of the resin foam. It will be understood that in the low-dielectric sheet for two-dimensional communication of a laminated structure, the total number of layers, the number of foamed layers made of the resin foam, the number of non-foamed layers, the thickness of each layer, etc. may be selected as appropriate depending on the intended use.

The non-foamed layer may be any layer having no foamed structure (cell structure) in it. For example, the non-foamed layer may be a layer made of the unfoamed, molded resin product, which is manufactured by shaping the resin composition into an appropriate shape (such as a sheet shape or a film shape). A single non-foamed layer may be used alone, or two or more non-foamed layers may be used in combination.

A pressure-sensitive adhesive layer may be provided on one or both surfaces of the low-dielectric sheet for two-dimensional communication of the invention. The pressure-sensitive adhesive for forming the pressure-sensitive adhesive layer is typically, but not limited to, a known pressure-sensitive adhesive such as a urethane pressure-sensitive adhesive, an acrylic pressure-sensitive adhesive, a rubber pressure-sensitive adhesive, a silicone pressure-sensitive adhesive, a polyester pressure-sensitive adhesive, a polyamide pressure-sensitive adhesive, an epoxy pressure-sensitive adhesive, a vinyl alkyl ether pressure-sensitive adhesive, or a fluoride pressure-sensitive adhesive. In particular, an acrylic pressure-sensitive adhesive or a rubber pressure-sensitive adhesive is preferred. These pressure-sensitive adhesives may be used alone or in combination of two or more. The pressure-sensitive adhesive may be in any form, such as an emulsion pressure-sensitive adhesive, a solvent pressure sensitive adhesive, or a hot melt-type pressure-sensitive adhesive (hot melt pressure-sensitive adhesive). The pressure-sensitive adhesive layer may be any of a single layer and a multilayer structure.

An electrically-conductive layer may also be provided in advance on the low-dielectric sheet for two-dimensional communication of the invention. The electrically-conductive layer can function as a component to form the communication sheet structure described below, and may be formed directly on at least one surface of the low-dielectric sheet for two-dimensional communication by plating with copper, nickel, or the like. Alternatively, the electrically-conductive layer may be formed by bonding, to the low-dielectric sheet for two-dimensional communication, a film having a surface on which copper, silver, aluminum, or the like is vapor-deposited, or by bonding, to the low-dielectric sheet for two-dimensional communication, a metal foil such as a copper foil or an aluminum foil. The electrically-conductive layer preferably has a surface resistivity of 1Ω or less, more preferably 0.5Ω or less, in particular, preferably 0.1Ω or less per 1 cm². The electrically-conductive layer generally has a thickness of 0.1 mm or less, preferably 0.001 mm to 0.1 mm, more preferably 0.001 mm to 0.05 mm.

The thickness of the low-dielectric sheet for two-dimensional communication is not restricted and selected as appropriate depending on the intended use, shape, mode, or the like of the low-dielectric sheet for two-dimensional communication. For example, it is typically from 0.5 to 5 mm, preferably from 0.5 to 2 mm.

The low-dielectric sheet for two-dimensional communication of the invention preferably has a bending rigidity of 100 N·mm² or less, more preferably 1 to 100 N·mm², in particular, preferably 1 to 50 N·mm², extremely preferably 1 to 30 N·mm². When the bending rigidity is 100 N·mm² or less, the sheet can have high flexibility and be formed into a roll.

(Communication Sheet Structure)

The communication sheet structure of the invention includes the low-dielectric sheet for two-dimensional communication of the invention as its part or is the low-dielectric sheet for two-dimensional communication itself.

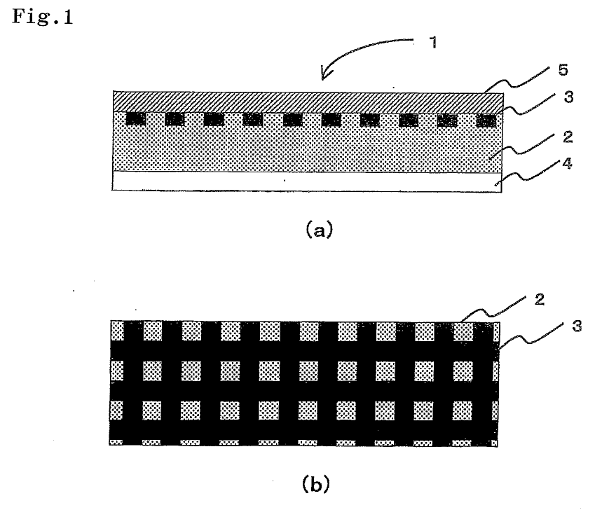

Hereinafter, the communication sheet structure of the invention is described with reference to FIG. 1. FIG. 1(a) is a schematic cross-sectional view of a communication sheet structure 1 according to the invention, and FIG. 1(b) is a top view of it. It should be noted that an insulating layer 5 is omitted from FIG. 1(b) so that FIG. 1(b) can show that an electrically-conductive mesh 3 is in the form of a lattice.

The communication sheet structure 1 according to the invention includes an electrically-conductive layer 4; the low-dielectric sheet for two-dimensional communication of the invention provided as a dielectric material 2 on the electrically-conductive layer 4; the electrically-conductive mesh 3 provided thereon; and the insulating layer 5 provided thereon.

The electrically-conductive layer 4 may be of any type having electromagnetic wave shielding properties. Preferably, it has a surface resistivity of 1Ω or less, more preferably 0.5Ω or less, most preferably 0.1Ω or less per 1 cm². As described above, the electrically-conductive layer 4 may be formed in advance on the low-dielectric sheet for two-dimensional communication, or a film having a surface on which copper, silver, aluminum, or the like is vapor-deposited or a metal foil such as a copper foil or an aluminum foil may be separately prepared and used to form the laminate. The thickness of the electrically-conductive layer 4 is generally 0.1 mm or less, preferably from 0.001 mm to 0.1 mm, more preferably from 0.001 mm to 0.05 mm.

As shown in FIG. 1(b), the electrically-conductive mesh 3 is formed of an electrically-conductive material in the shape of a lattice on the dielectric material 2. While the electrically-conductive mesh 3 shown in FIG. 1(b) is in the shape of a lattice, it may have a triangle shape, a quadrangular shape (such as a square, rectangle, rhombus, or trapezoid), or a circular shape (such as a perfect circle, nearly perfect circle, or ellipse) as long as it is porous or mesh-shaped. While FIG. 1(b) shows a structure with the electrically-conductive mesh 3 buried in the dielectric material 2, the electrically-conductive mesh 3 may be provided on the dielectric material 2. A material having electrical conductivity, such as a material comprising a metal such as copper, silver, aluminum, or nickel or a material comprising carbon black may be used to form the electrically-conductive mesh 3.

Any conventional well-known film having insulating properties, such as a polyester film, a polyolefin film, a vinyl chloride film, or a polyurethane film, may be used to form the insulating layer 5.

The respective layers may be bonded to one another by a conventional well-known method such as a method of bonding with hot-melt resin or a method of bonding by forming a pressure-sensitive adhesive layer.

The communication sheet structure of the invention includes the low-dielectric sheet for two-dimensional communication, which is characterized by having a dielectric layer with a density of 0.01 to 0.2 g/cm³ and a dielectric constant of 1.6 or less, and therefore can reduce energy loss and significantly increase communication performance.

### EXAMPLES

Hereinafter, the invention is described in more detail with reference to the examples, which however are not intended to limit the invention at all.

### Example 1

Polypropylene (0.35 g/10 minutes in melt flow rate (MFR) at 200° C.) was kneaded at a temperature of 200° C. in a twin screw kneader manufactured by The Japan Steel Works, LTD. (JSW) and then extruded into a strand, which was cooled with water and then cut into pellets.

The pellet was added to a single screw extruder manufactured by The Japan Steel Works, LTD., and carbon dioxide gas was injected thereinto at a pressure of 13 MPa/cm³ (12 MPa/cm³ after the injection) in an atmosphere at 220° C. The carbon dioxide gas was injected at a concentration of 9.5% by weight, based on the total amount of the polymer. After sufficient saturation with the carbon dioxide gas, the mixture was cooled to a temperature of 170° C. suitable for foaming and then extruded from the die to form a resin foam. Subsequently, the resin foam was sliced to form a low-dielectric sheet for two-dimensional communication with a thickness of 1.0 mm.

### Example 2

At a temperature of 200° C., 45 parts by weight of polypropylene (0.35 g/10 minutes in melt flow rate (MFR) at 200° C.), 45 parts by weight of a polyolefin elastomer (0.35 g/10 minutes in melt flow rate (MFR) at 200° C., 79 degrees in JIS A hardness), 10 parts by weight of magnesium hydroxide, 10 parts by weight of carbon (ASAHI #35 (trade name) manufactured by ASAHI CARBON CO., LTD.), and 10 parts by weight of stearic acid monoglyceride were kneaded in a twin screw kneader manufactured by The Japan Steel Works, LTD. (JSW) and then extruded into a strand, which was cooled with water and then cut into pellets.

The pellet was added to a single screw extruder manufactured by The Japan Steel Works, LTD., and carbon dioxide gas was injected thereinto at a pressure of 13 MPa/cm³ (12 MPa/cm³ after the injection) in an atmosphere at 220° C. The carbon dioxide gas was injected at a concentration of 5.6% by weight, based on the total amount of the resin composition. After sufficient saturation with the carbon dioxide gas, the mixture was cooled to a temperature of 170° C. suitable for foaming and then extruded from the die to form a resin foam. Subsequently, the resin foam was sliced to form a low-dielectric sheet for two-dimensional communication with a thickness of 1.0 mm.

### Example 3

At a temperature of 200° C., 45 parts by weight of polypropylene (0.35 g/10 minutes in melt flow rate (MFR) at 200° C.), 45 parts by weight of a polyolefin elastomer (0.35 g/10 minutes in melt flow rate (MFR) at 200° C., 79 degrees in JIS A hardness), 120 parts by weight of magnesium hydroxide, 10 parts by weight of carbon (ASAHI #35 (trade name) manufactured by ASAHI CARBON CO., LTD.), and 10 parts by weight of stearic acid monoglyceride were kneaded in a twin screw kneader manufactured by The Japan Steel Works, LTD. (JSW) and then extruded into a strand, which was cooled with water and then cut into pellets.

The pellet was added to a single screw extruder manufactured by The Japan Steel Works, LTD., and carbon dioxide gas was injected thereinto at a pressure of 13 MPa/cm³ (12 MPa/cm³ after the injection) in an atmosphere at 220° C. The carbon dioxide gas was injected at a concentration of 6.3% by weight, based on the total amount of the resin composition. After sufficient saturation with the carbon dioxide gas, the mixture was cooled to a temperature of 170° C. suitable for foaming and then extruded from the die to form a resin foam. Subsequently, the resin foam was sliced to form a low-dielectric sheet for two-dimensional communication with a thickness of 1.0 mm.

### Example 4

In an electroplating process, a 0.003 mm thick copper-plated layer was formed on one side of the low-dielectric sheet for two-dimensional communication prepared in Example 2, so that a low-dielectric sheet for two-dimensional communication having an electrically-conductive layer on one side was obtained.

### Example 5

A 30 μm thick aluminum vapor deposited film was placed on one side of the low-dielectric sheet for two-dimensional communication prepared in Example 2, with an acrylic pressure-sensitive adhesive (30 μm in thickness) interposed therebetween, so that a low-dielectric sheet for two-dimensional communication having an electrically-conductive layer on one side was obtained.

### Comparative Example 1

A foam composed mainly of polyurethane with a density of 0.4 g/cm³ and an average cell diameter of 70 μm was sliced to form a low-dielectric sheet for two-dimensional communication with a thickness of 1.0 mm.

The low-dielectric sheet for two-dimensional communications according to the examples and the comparative example were evaluated as described below. The results are shown in Table 1.

(Density Measurement Method)

The density of the resin foam prepared as the low-dielectric sheet for two-dimensional communication and the density of the molded pellet before the foaming were determined by a process including measuring the size of the test piece with a vernier caliper, then measuring the weight of it with an electronic balance, and calculating the density from the following formula: density (g/cm³)=the weight of the test piece/the volume of the test piece.

(Foaming Ratio)

The foaming ratio was calculated from the density of the molded pellet before the foaming and the density of the resin foam, according to the following formula: foaming ratio (times)=the density of the molded pellet before the foaming/the density of the resin foam.

(Average Cell Diameter)

A magnified image of a cell part of the foam was taken by using a digital microscope (VH-8000 (trade name) manufactured by KEYENCE CORPORATION) and subjected to image analysis by using image analysis software (Win ROOF (trade name) manufactured by MITANI CORPORATION), in which the average cell diameter (μm) of randomly-selected 400 cells was determined.

(Dielectric Loss Tangent)

The low-dielectric sheet for two-dimensional communication obtained in each of the examples and the comparative example was cut into an evaluation sample of 2 mm wide×70 mm long, which was measured for dielectric loss tangent value at 1 GHz by cavity resonator perturbation method (Vector Network Analyzer 8722A manufactured by Agilent Technologies, a cavity resonator manufactured by Kanto Electronic Application and Development Inc.).

(Dielectric Constant)

The low-dielectric sheet for two-dimensional communication obtained in each of the examples and the comparative example was cut into an evaluation sample of 2 mm wide×70 mm long, which was measured for dielectric constant value at 1 GHz by cavity resonator perturbation method (Vector Network Analyzer 8722A manufactured by Agilent Technologies, a cavity resonator manufactured by Kanto Electronic Application and Development Inc.).

(Surface Resistivity)

The surface resistivity was measured according to the dual-ring electrode method described in JIS K 6271. The resistivity was measured by using Digital Multimeter VOAC 7520 (instrument name) (manufactured by IWATSU TEST INSTRUMENTS CORPORATION).

(Bending Rigidity)

The sheet foam was cut into a test piece with a length of 100 mm, a width of 25 mm, and a thickness equal to the sheet foam thickness (when the sheet foam was a laminated sheet foam, the sheet foam thickness was the thickness of the sheet foam including the resin layer stacked therein), and the bending elastic constant E was measured according to JIS K 7203 (1982) by using the test piece. Subsequently, the bending rigidity EI [N·mm²] was calculated by substituting the bending elastic constant E and the size in the following formula: EI=Exb(h³/12), wherein E is the bending elastic constant [mPa], b is the length [mm] of the sample, and h is the thickness [mm] of the sample.

(Winding Workability)

The low-dielectric sheet for two-dimensional communication obtained in each of the examples and the comparative example was wound on a roll with a diameter of 100 mm and a length of 300 mm, when the presence or absence of the formation of wrinkles was observed.

TABLE 1

| | | | | | | Compar- |
|---|---|---|---|---|---|---|
| | | | | | | ative |
| | Exam- | Exam- | Exam- | Exam- | Exam- | Exam- |
| | ple 1 | ple 2 | ple 3 | ple 4 | ple 5 | ple 1 |
| Foaming | 38 | 22 | 16 | 22 | 22 | — |
| ratio | | | | | | |
| (times) | | | | | | |
| Foam | 0.024 | 0.045 | 0.085 | 0.045 | 0.045 | 0.40 |
| density | | | | | | |
| (g/cm³) | | | | | | |
| Average | 26 | 80 | 80 | 80 | 80 | 70 |
| cell | | | | | | |
| diameter | | | | | | |
| (μm) | | | | | | |
| Dielectric | 1.05 | 1.06 | 1.16 | 1.06 | 1.06 | 1.61 |
| constant | | | | | | |
| Dielectric | 0.0001 | 0.0003 | 0.0003 | 0.0003 | 0.0003 | 0.04 |
| loss | | | | | | |
| tangent | | | | | | |
| Surface | — | — | — | 0.0032 | 0.051 | — |
| resistivity | | | | | | |
| (Ω/cm²) | | | | | | |
| Bending | 4.05 | 4.05 | 5.12 | 16.2 | 24.5 | 6.07 |
| rigidity | | | | | | |
| (N/mm²) | | | | | | |
| Presence or | Absent | Absent | Absent | Absent | Absent | Absent |
| absence of | | | | | | |
| wrinkles | | | | | | |
| during | | | | | | |
| winding | | | | | | |

It has been demonstrated that the low-dielectric sheets for two-dimensional communication of the examples have a good level of dielectric constant and dielectric loss tangent. It has also been demonstrated that by using the methods of the examples for manufacturing a low-dielectric sheet for two-dimensional communication, low-dielectric sheets for two-dimensional communication with a good level of dielectric constant and dielectric loss tangent can be easily manufactured. It has also been demonstrated that the low-dielectric sheets for two-dimensional communication of the examples have low bending rigidity and can be formed into a roll.

### DESCRIPTION OF REFERENCE CHARACTERS

In the drawing, reference numeral 1 represents a communication sheet structure, 2 represents a dielectric material (low-dielectric sheet for two-dimensional communication), 3 represents an electrically-conductive mesh, 4 represents an electrically-conductive layer, and 5 represents an insulating layer.

1. A low-dielectric sheet for two-dimensional communication, having a density of 0.01 to 0.2 g/cm³ and a dielectric constant of 1.6 or less.

2. The low-dielectric sheet for two-dimensional communication according to claim 1, which has a dielectric loss tangent of 0.01 or less.

3. The low-dielectric sheet for two-dimensional communication according to claim 1, which contains cells.

4. The low-dielectric sheet for two-dimensional communication according to claim 3, wherein the cells have an average cell diameter of 1 to 300 μm.

5. The low-dielectric sheet for two-dimensional communication according to claim 1, which is made from a thermoplastic resin composition.

6. The low-dielectric sheet for two-dimensional communication according to claim 5, wherein the thermoplastic resin composition contains at least a polyolefin resin.

7. The low-dielectric sheet for two-dimensional communication according to claim 1, which has an electrically-conductive layer on at least one side.

8. The low-dielectric sheet for two-dimensional communication according to claim 7, wherein the electrically-conductive layer has a surface resistivity of 1Ω or less per 1 cm².

9. The low-dielectric sheet for two-dimensional communication according to claim 7, wherein the electrically-conductive layer has a thickness of 0.1 mm or less.

10. The low-dielectric sheet for two-dimensional communication according to claim 1, which has a bending rigidity of 100 N·mm² or less.

11. A communication sheet structure, comprising the low-dielectric sheet for two-dimensional communication according to claim 1.

12. A method for manufacturing a low-dielectric sheet for two-dimensional communication comprising a resin foam, which comprises foaming and molding a resin composition to form a resin foam with a density of 0.01 to 0.2 g/cm³ and a dielectric constant of 1.6 or less.

13. The method according to claim 12, wherein the resin composition is foamed by using a high-pressure gas.

14. The method according to claim 13, wherein the high-pressure gas is carbon dioxide or nitrogen.

15. The method according to claim 13, wherein the high-pressure gas is a supercritical fluid.

16. The method according to claim 14, wherein the high-pressure gas is a supercritical fluid.
